(19) United States
(12) Patent Application Publication
(10) Pub. No.: US 2009/0078503 A1
(43) Pub. Date: Mar. 26, 2009

(54) Collapsible Platform

(75) Inventor: Per-Olof Eriksson, Tranas (SE)

Correspondence Address: BREINER & BREINER, L.L.C., P.O. BOX 320160, ALEXANDRIA, VA, 22320-0160, US

(73) Assignee: TELESTEPS AB, TRANAS (SE)

(21) Appl. No.: 12/223,588

(22) PCT Filed: Feb. 6, 2007
(86) PCT No.: PCT/EP2007/051108

§ 371 Date: Oct. 24, 2008

(30) Foreign Application Priority Data
Feb. 7, 2006 (EP) 06002413.0

(51) Int. Cl. E06C 1/18; E06C 1/38; E06C 7/50; E06C 1/383; E06C 1/30

(52) U.S. Cl. 182/18; 182/104

(57) ABSTRACT

A collapsible stepladder including a first and a second ladder leg, where the legs are hingedly connected to each other in one end, and each of the ladder legs includes several ladder sections. Each section includes two ladder bars arranged parallelly to each other and interconnected at one end by a rung to form a U-shaped ladder section. Furthermore, each ladder section is telescopically inserted into a lower ladder section to form a collapsible ladder including at least three ladder sections, where the stepladder is provided with release mechanisms on each of the ladder legs that can be operated from the same side of the stepladder.

### FIELD OF THE INVENTION

The present invention relates to a collapsible freestanding ladder such as a stepladder or a combination ladder provided with ladder sections being telescopically inserted in each other.

### BACKGROUND OF THE INVENTION

Collapsible and expandable stepladders and combination ladders are known in the art. Examples of prior art stepladders are described below.

WO-A1-99/51848 discloses a telescopically collapsible stepladder comprising two legs that are hinged to one another. Each leg is formed of telescopically collapsible sections having latch mechanisms in each of the rungs for automatically locking the sections relative to one another when the leg is extended. The latch mechanisms in each rung are designed to release the next higher section when the rung is collapsed against the next lower rung. The separation of the rungs of one of the legs, when the stepladder is extended, is greater than the separation of the rungs in the other leg.

U.S. Pat. No. 4,989,692 discloses a ladder including two hinged sections, that can be oriented in an inverted V-configuration for use as a stepladder, or in a straight linear configuration for use as an ordinary, straight ladder. Each section of the ladder includes a number of U-shaped support units, each of which defining a crossbar and two downwardly extending side rails. The side rails of the different U-shaped units are of graduated cross sectional dimensions, so that the units can be contracted by telescopically sliding the aligned side rails within one another.

The problem with the above prior art is that the locking mechanisms need to be released from two sides to collapse the stepladder.

The object of the present invention is to overcome the disadvantages and problems with the prior art step ladders and to provide a stepladder which is easy and safe to handle and which can be completely collapsed by the user while the user is standing on one side of the stepladder through the process of releasing the locking mechanisms and collapsing the rungs of the stepladder.

### SUMMARY OF THE INVENTION

A stepladder according to the characterizing features of claim 1 solves the above and other problems.

The features of the dependent claims define further aspects of the claimed invention and preferred embodiments.

### BRIEF DESCRIPTION OF THE DRAWINGS

In the following, the invention will be explained with reference to the accompanying drawings, wherein:

FIG. 1 is a perspective view of the stepladder according to the invention having different retaining mechanisms of the two ladder legs;

FIG. 2 is a perspective view of an alternative configuration of the stepladder according to the invention having the same retaining mechanisms of the two ladder legs; and

FIG. 3 is a partial front view of the stepladder according to the invention.

### DETAILED DESCRIPTION OF THE EMBODIMENTS

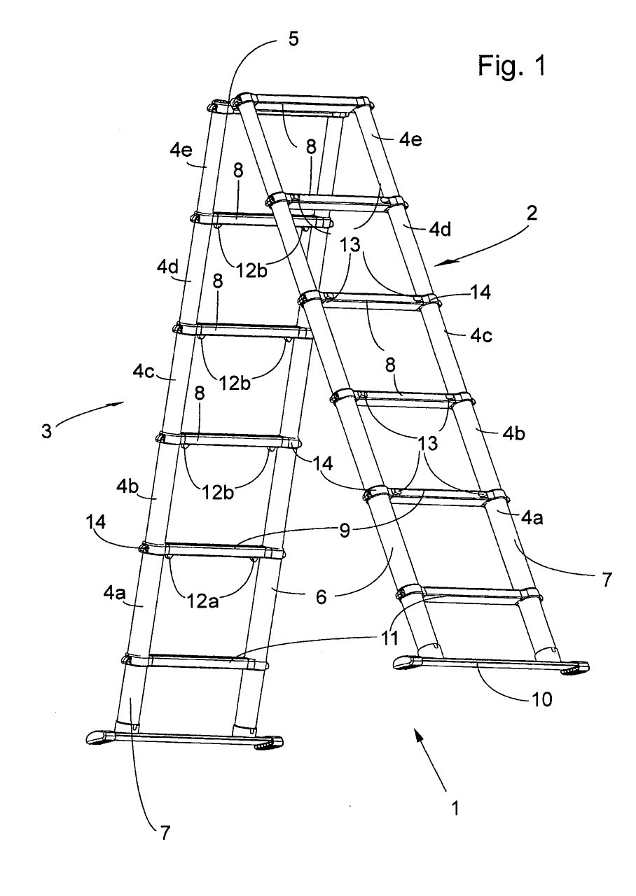

A collapsible stepladder 1 according to the invention is shown in the drawings. FIG. 1 shows a collapsible stepladder 1 comprising a first ladder leg 2, which is hingedly connected to a second ladder leg 3 in the upper ends of the first and second ladder legs 2, 3 by a hinge connection 5. Each of the ladder legs 2, 3 comprises several ladder sections 4b-4e, where each ladder section 4b-4e comprises two ladder bars 6, 7, arranged in parallel relationship and interconnected at one end by a rung 8 to form U-shaped ladder sections 4b-4e. The ladder sections 4b-4e are telescopically inserted into a lower ladder section to form a collapsible ladder leg 2, 3. The ladder legs 2, 3 further comprise a lower ladder section 4a, which comprises two ladder bars 6, 7, arranged in parallel relationship and interconnected at an upper end by a rung 9, at a lower end by a ladder base 10 and in between the rung 9 and the ladder base 10 by another rung 11. The ladder sections 4b-4e are telescopically inserted into the ladder section 4a.

Each of the ladder legs 2,3 should comprise at least three ladder sections 4a-4e, but in a preferred embodiment four collapsible ladder sections 4b-4e are arranged together with the lower ladder section 4a. The number of ladder sections is limited by the stability of the stepladder and the requirement to pass type approval.

Each rung 8, 9 comprises a retaining mechanism for automatically locking the ladder sections relatively to one another when the ladder legs 2,3 are extended. The retaining mechanism could be of any kind previously known in the art, e.g. any of the retaining mechanisms shown in EP-B1-0 527 766 or EP-A1-1 402 143.

In FIG. 1 the first ladder leg 2 is provided with the retaining mechanisms from EP-A1-1 402 143, i.e. a retaining mechanism 30 comprising a locking pin being spring biased towards an extended position in order to engage a locking hole provided in the ladder bar 6, 7 of a ladder section 4b-4e positioned thereabove and an actuator 13 for moving the locking pin into a retracted position and where the actuator 13 is arranged to be actuated outside the space between the rungs 8, 9 and is designed to be released manually and individually at both sides of a ladder section 4a-4d. The second ladder leg 3 is provided with the retaining mechanisms from EP-B1-0 527 766, i.e. a retaining mechanism 20 comprising locking pin biased being spring biased towards holes or recesses in the ladder bar 6 or 7 of the ladder section and release levers 12a, 12b for retracting the pins from the ladder bars 6, 7 when each rung 8 is collapsed onto the rung beneath, where the release levers 12b are located in the rungs 8 for automatically locking the ladder sections 4b-4d of the ladder bar relatively to one another when the sections 4b-4d are extended. The retaining mechanisms 20 of each rung 8, 9 are arranged to release the sections 4b-4e of the ladder bar connected to the next higher rung 8 when the rung 8 is collapsed against the next lower rung 8 or 9. The release levers 12a, which are arranged in the rung 9, are normally used for initiating the folding of ladder sections 4b-4d of the second ladder leg 3. The release levers 12a could be provided with rings to facilitate the use of the ladder.

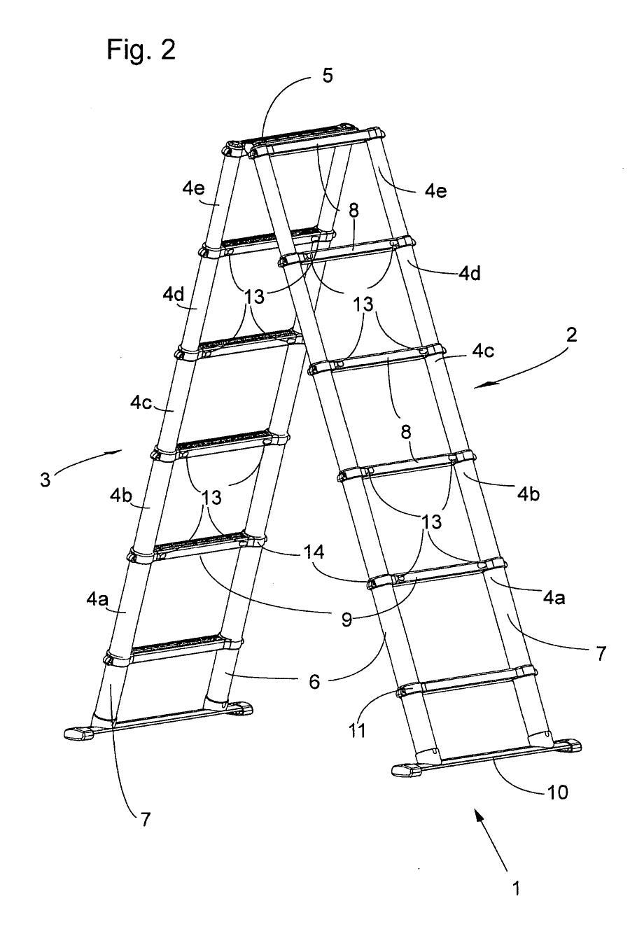

According to an alternative configuration, see FIG. 2, the second ladder leg 3 is provided with the same retaining mechanisms 30 having associated actuators 13, 13a, 13b as the first ladder leg 2.

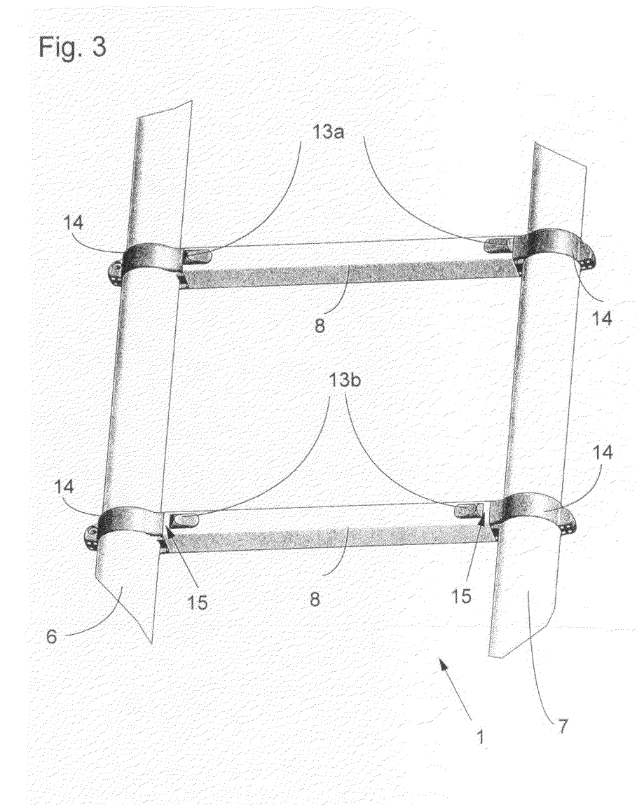

The actuators or push buttons 13a, 13b of the first ladder leg 2 is arranged such that if the locking pin is in the locked or retaining position, the actuator 13a will be adjacently arranged to the means 14 holding the ladder bars relatively to the rungs 8, 9, and such that no space is visible between the actuator 13a and the means 14 on the front of the rung 8, 9. If the locking pin has been retracted or moved from the retaining position by the actuator 13b, there will be a space 15 between the actuator 13b and the means 14 holding the ladder bars. This is a simple method of showing whether each retaining mechanism 30 is locked or unlocked, and informs the user whether a retaining mechanism 30 is locked or not. In order to further simplify for a user, the space might be coloured in a bright color, e.g. red. A red color visible in the space 15 would then warn, or inform, the user that the locking pin is in an unlocked position. Of course, it is possible to use any other color than red, but in a preferred embodiment of the invention, the color of the space 15 will differ significantly from the color of the actuator 13b; red is a preferred color since it is generally acknowledged as a “warning color”. Thereby the user is in a simple way informed whether the user safely can use the stepladder 1 or not. The means 14 for holding the ladder bars 6, 7 in relation to the rungs 8, 9 is a bracket 14. This is shown in FIG. 3. Preferably, the actuator 13a, 13b and the bracket 14 have the same color to further add to the safety information.

Now the steps of folding the collapsible stepladder 1 according to FIG. 1 will be described. The stepladder 1 is unfolded from the start. The user stands in front of the first ladder leg 2 and sticks his hand trough or beside the first ladder leg 2 and starts the folding process by pulling the rings of the lever 12a arranged on the rung 9 of the second ladder leg 3 downwards. Thereby, the locking pins associated with the retaining mechanisms of the rung 9 of the second ladder leg 3 is retracted from its extended position in order to disengage the locking hole provided in the ladder bar 6, 7 and the ladder section 4b of the second ladder leg 3 can be collapsed telescopically into the ladder section 4a of the second ladder leg 3.

Thereafter the user starts to fold the first ladder leg 2 by pushing the actuators or push buttons 13 of the rung 9 of the first ladder leg 2 so that the locking pin connected is retracted or moved from its extended or retaining position in order to disengage the locking hole of the ladder bars 6, 7. When the two actuators 13 of the rung 9 of the first ladder leg 2 are disengaged, the ladder section 4b of the first ladder leg 2 can be telescopically collapsed into the ladder section 4a of the first ladder leg 2. As the ladder section 4b of the first ladder leg 2 is inserted into the ladder section 4a of the first ladder leg 2, the ladder section 4b of the second ladder leg 3 also collapses and is inserted telescopically into the ladder section 4a of the second ladder leg 3.

When the rung 8 of the ladder section 4b of the first ladder leg 2 collapses onto the rung 9 of the first ladder leg 2. Thereby the rung 8 of the ladder section 4b of the second ladder leg 3 similarly collapses onto the rung 9 of the second ladder leg 3 and the release levers 12b located in the rung 8 of the ladder section 4b of the second ladder leg 3 is automatically pushed to disengage the locking pins of the rung 8 of the ladder section 4b of the second ladder leg 3. Thereby, the ladder section 4c of the second ladder leg 3 is unlocked and can be collapsed telescopically into the ladder section 4b of the second ladder leg 3.

Thereafter the user continues to fold the first ladder leg 2 by pushing the actuators or push buttons 13 of the rungs 8 of the ladder section 4b, 4c and 4d in a similar manner to fold the ladder sections 4c, 4d and 4e, respectively, of the first ladder leg 2. The ladder sections 4c, 4d, and 4e of the second ladder leg 3 are folded automatically as the corresponding ladder sections of the first ladder leg 2 are folded as described above such as has been described above.

The steps of unfolding the stepladder 1 are performed by extending all collapsed telescopic ladder sections so that the locking pins of the associated retaining mechanisms 12a, 12 and 13 are locked in the extended position by the retaining mechanisms 12a, 12 and 13, respectively.

The folding of the collapsible stepladder according to the alternative embodiment of FIG. 2 is carried out by releasing the retaining mechanisms of corresponding ladder sections (4b-4e) of the two ladder legs 2, 3 and folding the released ladder sections (4b-4e) in pairs.

The invention is not limited to the embodiments described above and shown in the drawings, but can be supplemented and modified in any manner within the scope of the invention as defined by the appended claims. E.g. the invention can be implemented on a combination ladder, i.e. a ladder that can be used both as a free-standing ladder and as a straight ladder.

1-8. (canceled)

9. A collapsible stepladder comprising a first ladder leg and a second ladder leg, wherein each of the first ladder leg and the second ladder leg is hingedly connected to one another in one end; each of the first ladder leg and the second ladder leg comprises a plurality of ladder sections; each section of the ladder sections comprises two ladder bars arranged in mutually parallel relationship and interconnected at one end by a rung to form a U-shaped ladder section; and wherein each said section of the ladder sections is telescopically inserted into a lower ladder section to form a collapsible ladder comprising at least three ladder sections, wherein the first ladder leg is provided with release mechanisms arranged on a front side of the rungs, and the second ladder leg is provided with release mechanisms arranged on an underside of a second lowermost rung.

10. The collapsible stepladder according to claim 9, wherein the release mechanisms are each a retaining mechanism comprising a locking pin which is spring biased towards an extended position in order to engage a locking hole provided in a ladder bar of a ladder section positioned thereabove and an actuator for moving the locking pin into a retracted position, wherein the actuator is arranged to be actuated outside a space between the rungs and manually releasable individually at both sides of the ladder section.

11. The collapsible stepladder according to claim 9, wherein the release mechanisms of the first ladder leg each include a retaining mechanism comprising a locking pin spring biased towards an extended position in order to engage a locking hole provided in a ladder bar of a ladder section positioned thereabove and an actuator for moving the locking pin into a retracted position, wherein the actuator is arranged to be actuated outside a space between the rungs and is manually releasable individually at both sides of a ladder section.

12. The collapsible stepladder according to claim 9, wherein the release mechanisms of the second ladder leg are each a retaining mechanism comprising pins biased by springs towards holes or recesses in a ladder bar of the ladder section and release levers for retracting the pins from the ladder bar when each rung is collapsed onto another rung thereunder, located in the rungs for automatically locking the ladder sections of the ladder bar relative to one another when the ladder sections are extended, and wherein the retaining mechanisms in each rung are arranged to release the sections of the ladder bar connected to a next higher rung when the next higher rung is collapsed against a next lower rung.

13. The collapsible stepladder according to claim 9, further comprising indicating means to show whether a release mechanism of the stepladder is in a locked position or in an unlocked position.

14. The collapsible stepladder according to claim 13, wherein the indicating means is formed by actuators of the release mechanism that in the locked position is adjacent to a bracket of the rung.

15. The collapsible stepladder according to claim 13, wherein the indicating means is formed by actuators of the release mechanism that in the unlocked position is separated from a bracket of the rung.

16. The collapsible stepladder according to claim 14, wherein the indicating means is formed by actuators of the release mechanism that in the unlocked position is separated from a bracket of the rung.

17. The collapsible stepladder according to claim 13, wherein the indicating means and the bracket of the rung are a common color.

18. The collapsible stepladder according to claim 14, wherein the indicating means and the bracket of the rung are a common color.

19. The collapsible stepladder according to claim 15, wherein the indicating means and the bracket of the rung are a common color.
